(19) United States
(12) Patent Application Publication
(10) Pub. No.: US 2023/0226812 A1
(43) Pub. Date: Jul. 20, 2023

(54) MANUFACTURING METHOD FOR NAIL ART STICKER

(71) Applicant: DAIKATECHKOREA CO., LTD., Seongnam-si (KR)

(72) Inventor: Kwang Hyun CHOI, Seongnam-si (KR)

(73) Assignee: DAIKATECHKOREA CO., LTD., Seongnam-si (KR)

(21) Appl. No.: 17/584,432

(22) Filed: Jan. 26, 2022

(30) Foreign Application Priority Data
Jan. 17, 2022 (KR) 10-2022-0006454

(51) Int. Cl. B32B 37/24; A45D 31/00; B32B 27/36; B32B 27/40; B32B 27/08; B32B 38/00; B32B 37/12; B32B 7/12; B32B 37/10

(52) U.S. Cl. CPC B32B 37/24; A45D 31/00; B32B 27/36; B32B 27/40; B32B 27/08; B32B 38/145; B32B 37/12; B32B 7/12; B32B 37/10; B32B 2367/00; B32B 2375/00; B32B 2037/243; B32B 2310/0831; B32B 2255/26; B32B 2255/10; B32B 2307/732

(57) ABSTRACT

A manufacturing method for a nail art sticker includes laminating and adhering a polyethylene terephthalate film to an upper surface of a base layer formed of elastic polyurethane; forming a first design layer by coating a UV paint on a lower surface of the base layer; depositing a mirror layer or a thin metal layer on an upper surface of the first design layer; coating a transparent pressure sensitive adhesive on an upper surface of the mirror layer or the thin metal layer and attaching a release liner film onto an upper surface of the transparent pressure sensitive adhesive; and forming a second design layer by removing the polyethylene terephthalate film from the base layer and coating the UV paint on the polyethylene terephthalate film removal surface.

### BACKGROUND

### (a) Technical Field

The present disclosure relates to a manufacturing method for a nail art sticker, and more particularly, to a manufacturing method for a nail art sticker capable of forming a design layer by coating and attaching a UV paint to both surfaces of a base layer and implementing various patterns by the UV paint.

### (b) Background Art

Recently, the beauty industry market has rapidly expanded and simultaneously, has begun to become popular with the general public.

In particular, nail art, a field of the beauty industry, is an essential element of expressive art for the body regardless of age or gender, and has been rapidly developed in recent years.

In general, the nail art mainly consists of applying liquid pigments such as various colors of manicures to nails or toenails, but such a method requires a technique for uniformly applying the liquid pigments.

Even if the liquid pigment is uniformly applied, not only it takes a long time to dry the liquid pigment, but also partial or total detachment occurs easily after drying, causing inconvenience to the user.

Accordingly, recently, UV gel nail has been in the spotlight, in which a liquid pigment containing a UV curing resin composition is applied to nails or toenails and then cured using a UV lamp.

However, when the UV gel nail is used for a long time, there is a disadvantage that chipping occurs in the gel part and thus, durability is not sufficient.

In addition, there is a cumbersome problem in a process in which a liquid gel nail is applied and then cured to the nail, and various shapes of patterns are attached thereon again in the form of stickers or drawn directly thereon, and then a strength reinforcing agent such as a top coat needs to be applied thereon again. In addition, in order to remove a UV gel layer, it is necessary to immerse the finger in a harmful solvent for a long time, which is very harmful to the skin and nails.

As another kind of nail art, in order to overcome the problems of liquid products such as manicures or UV gel nails, dry-type nail stickers have been developed, but most dry-type nail stickers have fixed shapes, and as a result, adhesion is poor, and durability after attachment is very weak, resulting in poor durability.

In addition, there are artificial nails with excellent durability, but the artificial nails lack flexibility and elasticity in the form of hard plastics so that the fitting and adhesion are poor. As a result, the artificial nails cannot be naturally seated on the nails, but lifted, and accordingly, there is a problem in that aesthetics is deteriorated, and foreign substances are accumulated and contaminated or harmful bacteria are introduced in a spaced space.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present disclosure is to solve the problems in the related art, and an object of the present disclosure is to provide a manufacturing method for a nail art sticker capable of expressing a metallic texture by coating and attaching a UV paint to both surfaces of a base layer and implementing various patterns by the UV paint to form first and second design layers.

Another object of the present disclosure is to provide a manufacturing method for a nail art sticker capable of applying excellent durability to a design layer by using a novel UV paint composition.

Yet another object of the present disclosure is to provide a manufacturing method for a nail art sticker capable of exhibiting luminance on a design layer by depositing a mirror layer or a thin metal layer on the upper surface of a first design layer.

According to an aspect of the present disclosure, there is provided a manufacturing method for a nail art sticker comprising:

a base step of laminating and adhering a polyethylene terephthalate film to an upper surface of a base layer formed of elastic polyurethane;

a first design layer forming step of forming a first design layer by coating a UV paint on a lower surface of the base layer;

a printing step of depositing a mirror layer or a thin metal layer on an upper surface of the first design layer;

a pressure sensitive adhesive sheet forming step of coating a transparent pressure sensitive adhesive on an upper surface of the mirror layer or the thin metal layer and attaching a release liner film onto an upper surface of the transparent pressure sensitive adhesive; and

a second design layer forming step of forming a second design layer by removing the polyethylene terephthalate film from the base layer and coating the UV paint on the polyethylene terephthalate film removal surface,

wherein the UV paint includes 12 to 24 wt % of urethane acrylate-based oligomer, 5 to 10 wt % of 2-propenoic acid, 2.5 to 5 wt % of 1,6-hexanediol diacrylate, 5 to 10 wt % of exo-1,7,7-trimethylbicyclo[2.2.1]heptyl acrylate, 0.5 to 3 wt % of phenylbis(2,4,6-trimethylbenzoyl)phosphine oxide, 0.5 to 3 wt % of α-hydroxy ketone, 3 to 10 wt % of a copolymer represented by the following Chemical Formula 1, and 40 to 60 wt % of a solvent:

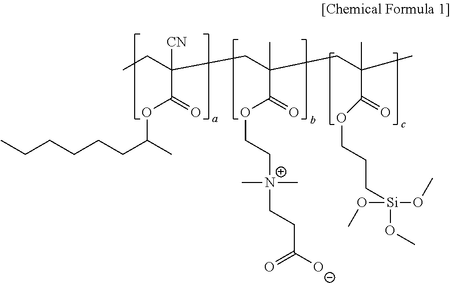

Wherein, a, b, and c are mole fractions, and

wherein a is 0.3 to 0.7, b is 0.1 to 0.3, c is 0.2 to 0.4, and a+b+c is 1.

In the base step, the thickness of the base layer may be formed at a thickness of 25 μm to 75 μm, preferably 35 μm to 45 μm.

In the base step, the thickness of the polyethylene terephthalate film is formed at a thickness of 75 μm to 150 μm, preferably 90 μm to 110 μm.

The first design layer forming step may further include a paint disposing step of disposing a UV paint on one side of a mold; a pressing step of seating a lower surface of the base layer onto the mold and then inserting the mold into a roller; a UV forming step of coating and attaching the UV paint on the lower surface of the base layer by pressing the roller and forming various patterns on the UV paint to form the first design layer; and a curing step of curing the corresponding resin layer by irradiating UV toward the first design layer.

The second design layer forming step may further include a paint disposing step of disposing a UV paint on one side of a mold; a pressing step of seating the polyethylene terephthalate film removal surface of the base layer onto the mold and then inserting the mold into a roller; a UV forming step of coating and attaching the UV paint on the polyethylene terephthalate film removal surface of the base layer by pressing the roller and forming various patterns on the UV paint to form the second design layer; and a curing step of curing the corresponding resin layer by irradiating UV toward the second design layer.

In the printing step, a reflective surface may be formed on the upper surface of the first design layer so that the design layer exhibits luminance.

In the pressure sensitive adhesive forming step, the thickness of the transparent pressure sensitive adhesive may be formed at a thickness of 25 μm to 125 μm, preferably 48 μm to 52 μm.

According to the present disclosure, the manufacturing method for the nail art sticker has an advantage of satisfying consumer's needs by forming the first and second design layers by attaching a UV paint onto both surfaces of the base layer and forming various patterns on the UV paint to implement a metallic texture which is difficult to be implemented in conventional nail stickers.

Further, it is possible to provide an effect of applying excellent durability to a design layer by using a novel UV paint composition.

Further, there is an advantage of expressing a better metallic texture and exhibiting higher luminance of a first design layer than conventional nail stickers by depositing and printing a mirror layer or thin metal layer on the upper surface of the first design layer.

### BRIEF DESCRIPTION OF THE DRAWINGS

FIG. 1 is a flowchart illustrating a process of a manufacturing method for a nail art sticker according to an embodiment of the present disclosure.

FIG. 2 is an exemplary diagram illustrating a base step and a first design layer formation preparing step in the manufacturing method for the nail art sticker according to the embodiment of the present disclosure.

FIG. 3 is an exemplary diagram illustrating a first design layer forming step in the manufacturing method for the nail art sticker according to the embodiment of the present disclosure.

FIGS. 4 and 5 are exemplary diagrams illustrating a pressure sensitive adhesive sheet forming step in the manufacturing method for the nail art sticker according to the embodiment of the present disclosure.

FIG. 6 is an exemplary diagram illustrating a photograph of a state attached onto nails using the manufacturing method for the nail art sticker according to the embodiment of the present disclosure.

### DETAILED DESCRIPTION

Hereinafter, preferred embodiments in which those of ordinary skill in the art to which the present disclosure pertains can easily implement the present disclosure will be described in detail with reference to the accompanying drawings. However, in describing in detail an operational principle of preferred embodiments of the present disclosure, a detailed description of known functions and configurations incorporated herein will be omitted when it is determined that the subject matter of the present disclosure may be unnecessarily obscured.

In addition, the same reference numerals are used throughout the drawings for parts having similar functions and actions.

Further, throughout this specification, when a certain part is “connected” with the other part, it means that the certain part may be not only “directly connected” with the other part, but also indirectly connected with the other part with another component interposed therebetween. Unless explicitly described to the contrary, the term of “including” any component means further including another component, rather than excluding another component.

Hereinafter, a manufacturing method for a nail art sticker according to preferred embodiments of the present disclosure will be described in detail with reference to the accompanying drawings.

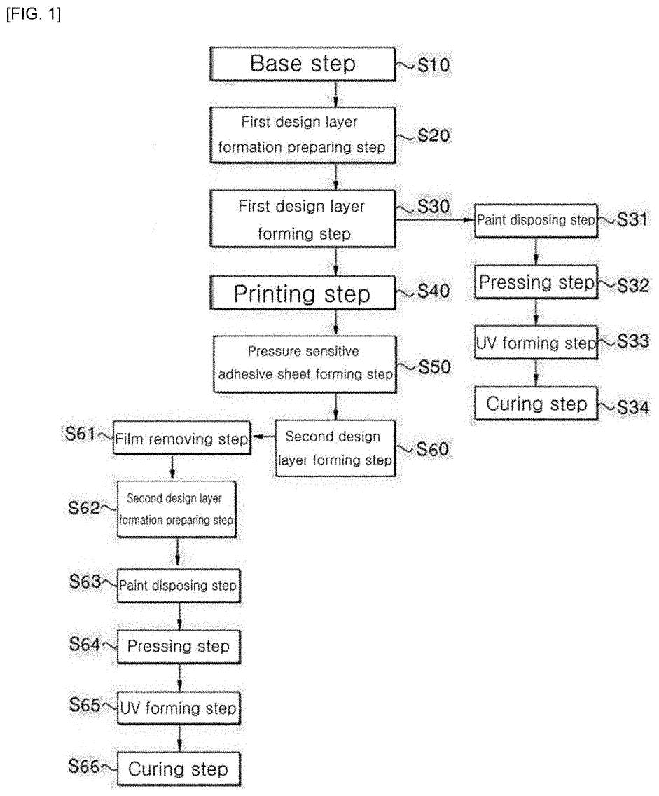

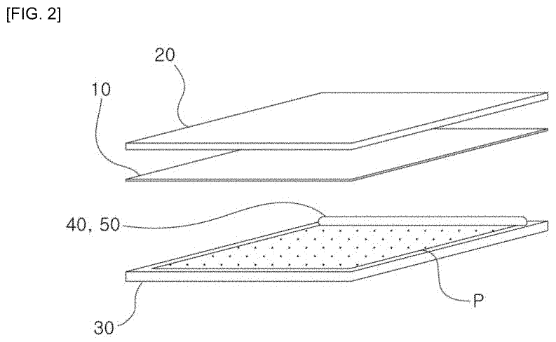

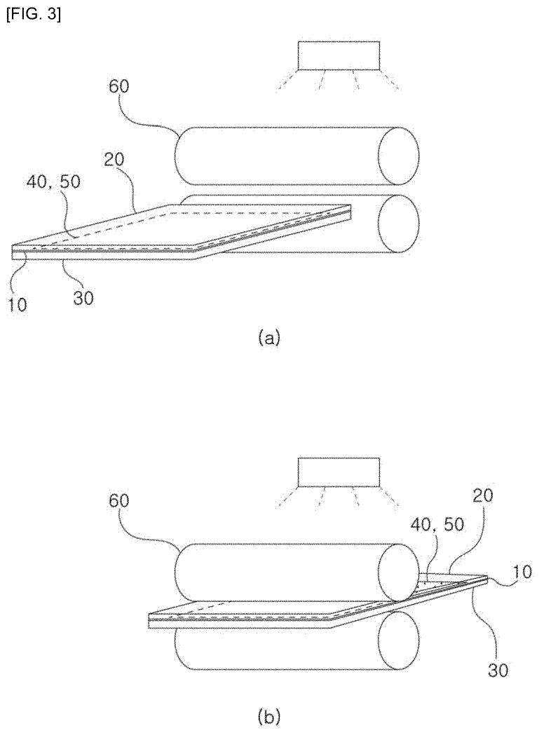

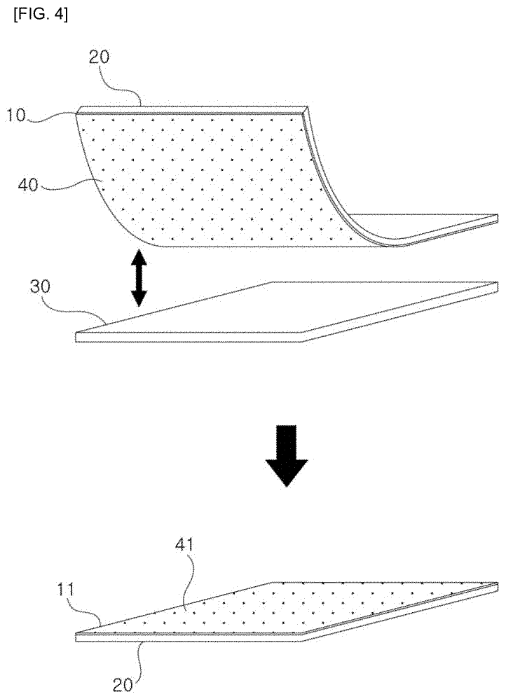

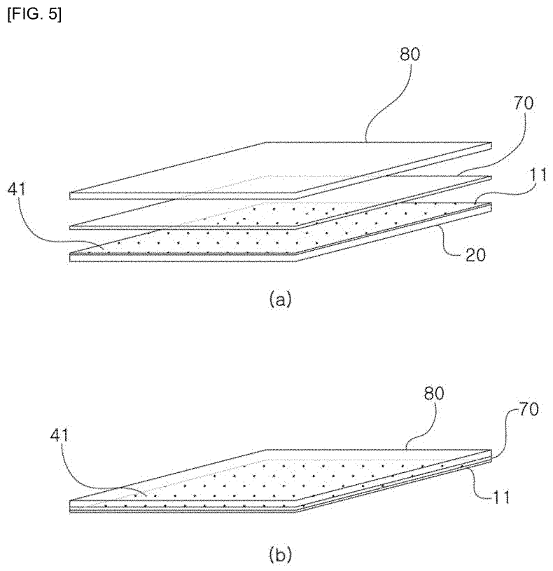

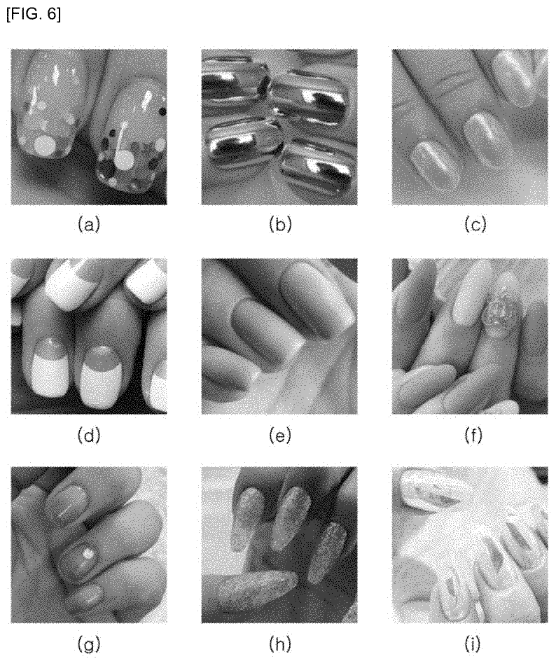

FIG. 1 is a flowchart illustrating a process of a manufacturing method for a nail art sticker according to an embodiment of the present disclosure, FIG. 2 is an exemplary diagram illustrating a base step and a first design layer formation preparing step in the manufacturing method for the nail art sticker according to the embodiment of the present disclosure, FIG. 3 is an exemplary diagram illustrating a first design layer forming step in the manufacturing method for the nail art sticker according to the embodiment of the present disclosure, FIGS. 4 and 5 are exemplary diagrams illustrating a pressure sensitive adhesive sheet forming step in the manufacturing method for the nail art sticker according to the embodiment of the present disclosure, and FIG. 6 is an exemplary diagram illustrating a photograph of a state attached onto nails using the manufacturing method for the nail art sticker according to the embodiment of the present disclosure.

As illustrated in FIG. 1, a manufacturing method S for a nail art sticker according to an embodiment of the present disclosure includes a base step (S10), a first design layer formation preparing step (S20), a first design layer forming step (S30), a printing step (S40), an adhesive sheet forming step (S50), and a second design layer forming step (S60).

In more detail, as illustrated in FIG. 1, the manufacturing method S for the nail art sticker according to an embodiment of the present disclosure includes the base step (S10) of adhering a polyethylene terephthalate film 20 to the upper surface of a base layer 10 formed of elastic polyurethane, the first design layer formation preparing step (S20) of providing a mold 30 having various patterns formed on one surface thereof and disposing the lower surface of the base layer above the mold, the first design layer forming step (S30) of forming a first design layer 40 on the lower surface of the base layer by binding the base layer and the mold, the printing step (S40) of separating the mold, inverting the base layer, and depositing a mirror layer or a thin metal layer on the upper surface of the first design layer 40, the pressure sensitive adhesive sheet forming step (S50) of applying a transparent pressure sensitive adhesive onto the upper surface of the mirror layer or the thin metal layer and attaching a release liner film onto the upper surface of the transparent pressure sensitive adhesive, and the second design layer forming step (S60) of removing the polyethylene terephthalate film from the base layer and coating a UV paint on the polyethylene terephthalate film removal surface to form a second design layer.

Referring to FIGS. 1 and 2, in the base step (S10), the base layer 10 formed of elastic polyurethane which is cut in a predetermined size or wound in a roll form is prepared in advance.

The elastic polyurethane (EPU) is a film having better elongation and elasticity than general polyurethane, and has high transparency and excellent heat resistance strong to heat and excellent elasticity to have good restoring force. As the elastic polyurethane, materials known in the art may be used without limitation.

The polyethylene terephthalate film 20 layer compensates for the physical strength of the base layer 10 having relatively softness by adhering the polyethylene terephthalate film 20 to the upper surface of the base layer 10 formed of such elastic polyurethane (EPU).

On the other hand, in the base step (S10), it is preferred to form the thickness of the base layer 10 to 25 μm to 75 μm, preferably 35 μm to 45 μm.

At this time, when the thickness of elastic polyurethane (EPU) is too thick, it is difficult to be cut along the edge of the nail by attaching the base layer 10 to the nail. In addition, in the first design layer forming step (S30) of forming the design layer 40, there is a problem that the compression force of a roller 60 is increased, so that a pattern P cannot be formed on the UV paint 50.

In addition, when the thickness of the base layer 10 is too thin, there may be a deformation and damage problem such that the base is torn or stretched due to the thickness of the UV paint 50 even if the compression force of the roller 60 is adequate in the first design layer forming step (S30). In addition, when the base layer is attached to the nail, due to the thin thickness, the surface may be wrinkled or lifted easily, which may decrease the value of the product.

For this reason, it is preferable to select and apply a thickness of the polyethylene terephthalate (PET) film 20 used in the base step (S10) to 75 μm to 150 μm, preferably 90 μm to 110 μm.

Since the polyethylene terephthalate (PET) film 20 has higher tensile and strength than elastic polyurethane (EPU), the polyethylene terephthalate (PET) film 20 serves as a support to prevent the base layer 10 from being deformed in the first design layer forming step (S30). As the polyethylene terephthalate, any component known in the art may be used without limitation.

In general, if the thickness of the polyethylene terephthalate (PET) film 20 is too thin or too thick, there is a problem in the process of forming the first design layer 40 on the base layer 10, making it difficult to be manufactured.

Referring to FIG. 2, in the first design layer formation preparing step (S20) is a process of providing the mold 30 with various patterns P formed on one surface thereof and disposing the lower surface of the base layer above the mold 30.

Here, the mold 30 serves to implement a desired pattern on a target surface by the UV paint 50 by forming the various patterns P on one surface thereof.

In addition, the pattern P is formed to include at least one of a color, a glitter, a gradation, a sequin, a pattern, and a design to have an aesthetic feeling.

Referring to FIG. 3, the first design layer forming step (S30) is a process of forming the first design layer 40 on the lower surface of the base layer 10 by binding the base layer 10 and the mold 30.

To this end, the first design layer forming step (S30) further includes a paint disposing step (S31), a pressing step (S32), a UV forming step (S33), and a curing step (S34).

In the paint disposing step (S31), for example, by disposing the UV paint 50 on one side of the mold 30, the UV paint 50 capable of forming the pattern P is disposed in a paste form to be elongated in a length direction.

The pressing step (S32) is a process of seating the lower surface of the base layer 10 onto the mold 30 and then inserting the mold 30 into the roller 60.

The UV forming step (S33) is a process of coating the UV paint 50 on the lower surface of the base layer 10 by pressing the roller 60, and forming the design layer 40 by implementing various patterns through the UV paint 50.

For example, when the base layer 10 and the mold 30 are bound into a single layer to be introduced into the roller 60, the pressure is applied by the rotation of the roller 60 so that the UV paint 50 positioned at one side of the lower surface of the base layer 10 is spread to the other side of the lower surface of the base layer 10.

At this time, one surface of the UV paint 50 is coated and attached onto the lower surface of the base layer 10, and the pattern P formed by the mold 30 is implemented on the other surface of the UV paint 50 to form the first design layer 40.

Thereafter, when the base layer 10 and the mold 30 that have passed through the roller 60 are separated from each other and an appropriate amount of UV is irradiated toward the UV paint 50 remaining on the other side of the mold, a paint separating step of separating the UV paint 50 from the mold 30 may be further included.

The curing step (S34) is curing the first design layer 40 by irradiating UV toward the first design layer 40, so that the first design layer 40 adhered to the lower surface of the base layer 10 may be firmly configured and positioned.

Referring to FIG. 4, the printing step (S40) is a process of separating the mold 30, inverting the base layer 10, and depositing the mirror layer or the thin metal layer on the upper surface of the first design layer 40.

In this printing step (S40), a reflective surface is formed on the upper surface of the first design layer 40 so that the first design layer 40 may exhibit luminance. For this reason, the pattern P formed on the first design layer 40 is reflected to have an effect of expressing a richer aesthetics, and it is possible to have an advantage of being displayed fancier by excellent luminance.

Referring to FIGS. 4 and 5, the pressure sensitive adhesive sheet forming step (S50) is a process of applying a high transparent & clear pressure sensitive adhesive (HTC PSA) 70 on the upper surface of the mirror layer or the metal layer.

The high transparent & clear pressure sensitive adhesive (HTC PSA) 70 has excellent adhesion as an optically transparent adhesive and is used for a process of being selectively applied or laminated and bound only to a desired area.

Due to this, the first design layer 40 is transmitted to an opposite surface to be visually recognized.

In addition, in the pressure sensitive adhesive sheet forming step (S50), it is preferred to form the thickness of the high transparent & clear pressure sensitive adhesive (HTC PSA) 70 to 25 μm to 125 μm, preferably 48 μm to 52 μm.

As the HTC PSA, a pressure sensitive adhesive known in the art may be used. Generally, an acrylic copolymer resin is used, and may be divided into a solvent type and a solvent-free type according to a manufacturing process. In general, the solvent-type pressure sensitive adhesive is cured by hot air drying, and yellowing or discoloration to milky white may be accompanied by sunlight, heat, or environmental factors. On the other hand, there are typically UV-curable and hot-melt types as a solvent-free pressure sensitive adhesive, and the UV-curable adhesive is usually used due to excellent ease of implementation of thickness during coating.

When comparing the solvent-based pressure sensitive adhesive and the solvent-free pressure sensitive adhesive, in the case where the thickness of the pressure sensitive adhesive is thick, there is a problem in a possibility that the solvent type may contain residual organic volatile components. On the other hand, in the case of the solvent-free type, particularly, a UV-curable type, there is an advantage of being able to eliminate or alleviate a lot of these problems or concerns.

For example, a main material of the acrylic pressure sensitive adhesive includes acrylic acid, 2-ethylhexyl (meth)acrylate, butyl acrylate, ethyl acrylate, isooctyl acrylate, hydroxyethyl (meth)acrylate, hydroxy propyl acrylate, isobornyl acrylate, methyl (meth)acrylate, normal vinyl pyrrolidine, N,N-vinyl caprolactam, and the like. A general composition may be constituted at a ratio of 80% or more of monomers having Tg of 0° C. or less and 20% or less of monomers having Tg of 50° C. or more based on a glass transition temperature (Tg) of the acrylic monomers. A UV photoinitiator commonly used in the acrylic pressure sensitive adhesive typically includes azobisisobutyronitrile (AIBN) or benzoyl peroxides (commercial products include Omnirad 184, 651, 819, etc. by iGM), and as the crosslinking agent, acryl monomers with a bifunctional group or a trifunctional group or more such as 1,6-hexanediol diacrylate, azyl azides, or diazirine-based compounds are used. The amount (based on TPO) of the photoinitiator used in the UV pressure sensitive adhesive is 0.15 to 1.5 pph (part per hundred of resin) per 100 parts of the acrylic pressure sensitive adhesive resin, which is smaller than that of a general-purpose UV coating agent, and an amount of photocrosslinking agent is also in the range of 0.02 to 1.0 pph, which is smaller than that of the UV coating agent.

The acrylic pressure sensitive adhesive used in the present disclosure includes 1) a general pressure sensitive adhesive product containing a carboxylic acid group, 2) a product without containing a carboxylic acid group, and 3) a medical anon-irritating pressure sensitive adhesive used for disposable bandages or bandaids.

The 1) pressure sensitive adhesive containing the carboxylic acid group includes 75 to 99% by weight of butyl acrylate (BA), 2-ethyl hexyl acrylate (2-EHA) and isooctyl acrylate (IOA), which are general soft monomers (glass transition temperature below zero), and 0.2 to 25% by weight of acrylic acid (AA) or (methyl) methacrylic acid ((M)MA), which is a hard monomer (glass transition temperature of 80° C. or higher), wherein a photoinitiator is contained in 0.01 to 2.5 parts (an addition amount varies depending on a molar concentration for each initiator) and a crosslinking agent is contained in 0.05 to 2.0 parts per 100 parts of the acrylic resin.

The 2) product without containing the carboxylic acid group has a composition of 30 to 60% of BA, 2-EHA and IOA as soft monomers, 20 to 50% of isobornyl acrylate (IBOA) or lauryl acrylate (LA) as a nonpolar monomer, and 10 to 40% of hydroxyethyl acrylate (HEA) or hydroxyproryl acrylate (HPA) having a hydroxyl group, wherein the photoinitiator is contained in 0.15 to 3.0 parts (an addition amount varies depending on a molar concentration for each initiator) and a crosslinking agent is contained in 0.04 to 3.0 parts per 100 parts of the acrylic resin.

The 3) medical non-irritating pressure sensitive adhesive used for the disposable bandages or bandaids includes a composition of 60 to 95% of 2-EHA or IOA as the soft monomer and 3 to 50% of normal vinyl pyrrolidine (NVP), wherein the photoinitiator is contained in 0.14 to 2.5 parts (an addition amount varies depending on a molar concentration for each initiator) and a crosslinking agent is contained in 0.06 to 2.0 parts per 100 parts of the acrylic resin.

In the pressure sensitive adhesive composition, a hydrocarbon-based, rosin ester-based, or terpene-phenyl-based tackifier may be used if necessary for the purpose of increasing initial tack and adhesion. However, in general, a general-purpose tackifier is used to cause yellowing or discoloration and pressure sensitive adhesive leakage (so-called draining), and as a result, in the case of products sensitive to clearness or appearance and changes in color, the use of the tackifier is limited. To solve this problem, in the product of the present disclosure, an acrylic tackifier (acrylic copolymer resin with a high glass transition temperature and a low molecular weight) having yellowing and changes in color or appearance is used.

In addition, when a pressure sensitive adhesive part unintentionally comes into contact with the skin when being attached to the nails to cause skin irritation, there may be an advantage that a pressure sensitive adhesive made of raw materials excluding functional groups that may cause other chemical problems, such as a carboxyl group (acid) or a hydroxyl group (base), is adopted to minimize the possibility of skin irritation. At this time, if the thickness of the pressure sensitive adhesive is too thick, the pressure sensitive adhesive layer is not detached, but stretched and damaged when a release liner film 80 to be described below is detached, so that the first design layer 40 may be deformed or the first design layer 40 and the second design layer may be wrinkled.

In addition, if the thickness is too thin, the adhesive force is too low and proper adhesive performance is lost, so that the release liner film 80 cannot protect the base layer 10 and the first design layer 40.

The adhering step is a process of laminating and attaching the release liner film 80 on the upper surface of the high transparent & clear pressure sensitive adhesive (HTC PSA) 70.

The release liner film 80 is provided to protect the first design layer 40, and in the second design layer forming step (S60), the second design layer is further formed on the other side of the base layer on which the first design layer 40 is already formed to protect the formed first design layer 40 when introduced into the roller 60.

In this adhering step, the thickness of the release liner film is preferably formed in a range of 75 μm to 150 μm, preferably 90 μm to 110 μm.

The peeling force of the release liner film is appropriately 50 g/25 mm or more, and less than 300 g/25 mm based on a 180° peel adhesion test (peel rate of 300 mm/min, an adhesive tape used is Tesa #7475; measure within 30 minutes after attaching and pressing), and the thicker the pressure sensitive adhesive tape, the lower the peeling force is used. In addition, the thickness of the release liner film is proportionally thicker as the adhesive force is higher and the coating thickness of the pressure sensitive adhesive is thicker.

On the contrary, when the thickness of the pressure sensitive adhesive is thin, it is good that the release force of the release liner film is also high, so as to ensure maximally the adhesion to the pressure sensitive adhesive surface and enable the release liner film to be adhered and maintained well even under a low adhesion at the same time. The thickness of the release liner film is also lower as the adhesive strength is lower and the coating thickness of the pressure sensitive adhesive is thinner (in the case of the release liner film having the same peeling force, the thinner the thickness, the better the adhesion of the surface of the pressure sensitive adhesive and the flexibility that each layer is maintained without detaching after attachment).

The second design layer forming step (S60) is a process of forming a desired pattern P on the opposite surface of the surface on which the first design layer of the base layer is formed.

To this end, the second design layer forming step (S60) further includes a film removing step (S61), a second design layer formation preparing step (S62), a paint disposing step (S63), a pressing step (S64), a UV forming step (S65), and a curing step (S66).

Referring to FIG. 5, the film removing step (S61) is a process of removing the polyethylene terephthalate (PET) film 20 adhered to one surface of the base layer 10. The second design layer formation preparing step (S62) is a process of disposing the mold 30 on the surface of the base layer 10 from which the polyethylene terephthalate (PET) film 20 is removed.

The second design layer forming step (S60) is a process of forming the second design layer by binding the surface of the base layer 10 from which the PET film 20 is removed to the mold 30 and pressing the mold with the roller 60.

For example, the UV paint 50 is disposed on one side of the mold 30 and the surface of the base layer 10 from which the PET film 20 is removed is seated on the mold 30 to be introduced into the roller 60 in the form bound into a single layer.

At this time, the UV paint 50 is uniformly spread and adhered by pressing the roller 60, and the pattern P formed on the mold 30 is formed on the UV paint 50 to form the second design layer. Thereafter, the process proceeds in the same manner as in the curing step (S34) of the first design layer forming step (S30).

The UV paint used in the present disclosure may include 12 to 24 wt % of urethane acrylate-based oligomer, 5 to 10 wt % of 2-propenoic acid, 2.5 to 5 wt % of 1,6-hexanediol diacrylate, 5 to 10 wt % of exo-1,7,7-Trimethylbicyclo[2.2.1]heptyl acrylate, 0.5 to 3 wt % of phenylbis(2,4,6-trimethylbenzoyl)phosphine oxide, 0.5 to 3 wt % of α-hydroxy ketone, 3 to 10 wt % of a copolymer represented by the following Chemical Formula 1, and 40 to 60 wt % of a solvent.

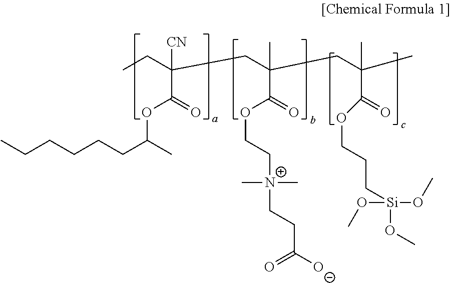

Wherein, a, b, and c are mole fractions,

wherein a is 0.3 to 0.7, b is 0.1 to 0.3, c is 0.2 to 0.4, and a+b+c is 1.

As the urethane acrylate-based oligomer, for example, an oligomer represented by the following Chemical Formula may be used.

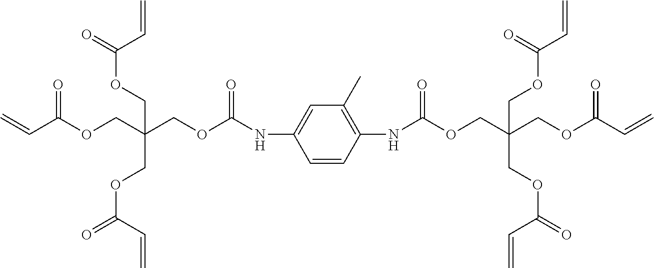 [SMILES: C=CC(=O)OCC(COC(=O)C=C)(COC(=O)C=C)COC(=O)Nc1ccc(NC(=O)OCC(COC(=O)C=C)(COC(=O)C=C)COC(=O)C=C)c(C)c1]

(Product name: CN975, manufacturer: Sartomer Corporation, Exton, Pa.)

When the copolymer represented by Chemical Formula 1 is included in the aforementioned content range, the durability of the first and second design layers formed of the UV paint is greatly improved. That is, since chipping does not occur even when used for a long time, excellent durability is provided.

A structural unit derived from 3-[[2-(Methacryloyloxy)ethyl]dimethylammonio]propionate (CAS No. 24249-95-4) included in the copolymer of Chemical Formula 1 above includes an ammonium cation and an ester anion and has a charge to perform a function so that the components included in the paint are well dispersed. The structural unit derived from 2-octylcyanoacrylate is a monomer that forms a very strong bond with both organic and inorganic materials, and allows the UV paint to be more firmly fixed to the base layer. The structural unit derived from 3-(trimethoxysilyl)propyl methacrylate functions to prevent chipping from occurring in the UV paint film.

The copolymer of Chemical Formula 1 is a random copolymer, and may have a weight average molecular weight of 50,000 to 1,000,000, more preferably 150,000 to 350,000.

The coating film formed of the UV paint has a characteristic to be cured with an exothermic reaction rapidly when irradiated with light in a UV A region (wavelength of 310 to 390 nm) having a light quantity and illuminance above appropriate levels required for curing. At this time, the UV light energy required for correct curing varies depending on the thickness of the coating film and the type of cured resin (chemical classification), and usually, when the thickness of the coating film is 200 μm, an illuminance of 1.5 mW/sec or more and a light quantity of 500 mJ/cm² or more are required. As the thickness of the coating film increases, the light quantity required for complete curing under a predetermined illuminance increases in proportion to the thickness.

As illustrated in FIG. 6, the manufacturing method S of the nail art sticker according to the embodiment of the present disclosure includes a glitter pattern h, a mirror pattern b, and a matte pattern f, which are metallic textures that cannot be implemented in the conventional nail art stickers.

In particular, in the manufacture of the conventional nail art stickers, a pattern is formed only on one side of the film and the pattern is not formed on the other side of the film. This is because it is difficult to be implemented by a generally known process.

As a result, the conventional nail art stickers have no choice but to implement remarkably lower design patterns than the glitter pattern h, the mirror pattern b, and the matte pattern f of the sticker manufactured by the manufacturing method S of the nail art sticker according to the embodiment of the present disclosure.

Hereinafter, the present disclosure will be described in more detail with reference to Preparation Examples and Examples. However, the following Examples are for explaining the present disclosure in more detail, and the scope of the present disclosure is not limited by the following Examples. The following Examples can be appropriately modified and changed by those skilled in the art within the scope of the present disclosure.

### Preparation Example 1: Preparation of UV Paint

A UV paint was prepared by mixing 20 wt % of urethane acrylate-based oligomer, 8 wt % of 2-propenoic acid, 3.5 wt % of 1,6-hexanediol diacrylate, 7.5 wt % of exo-1,7,7-trimethylbicyclo[2.2.1]heptyl acrylate, 2 wt % of phenylbis(2,4,6-trimethylbenzoyl)phosphine oxide, 2 wt % of α-hydroxy ketone, 6 wt % of a copolymer represented by the following Chemical Formula 1, and 26 wt % of methylethyl ketone and 25 wt % of ethyl acetate.

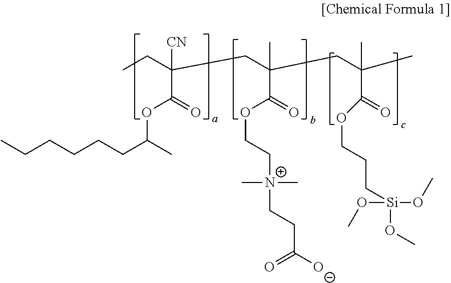

Wherein, a, b, and c are mole fractions, and a=0.5, b=0.2, and c=0.3.

### Synthesis of copolymer of Chemical Formula 1

2-octylcyanoacrylate, 3-[[2-(methacryloyloxy)ethyl]dimethylamino]propionate (3-[[2-(Methacryloyloxy)ethyl]dimethylammonio]propionate (CAS No. 24249-95-4), and 3-(trimethoxysilyl)propyl methacrylate) were added to ethyl benzene as a reaction solvent in a molar ratio of 0.5:0.2:0.3, and 0.5 parts by weight of normal mercaptan was mixed to 100 parts by weight of the total monomers to be uniform.

The polymerization solution prepared above was put into a 20 L reactor at a rate of 10 L/hr and polymerized at a temperature of 100° C., and in a volatilization tank, unreacted monomers and a reaction solvent were removed at a temperature of 150° C., and washed, dehydrated, and dried to obtain a copolymer of Chemical Formula 1 having a weight average molecular weight of 285,000.

### Preparation Example 2: Preparation of UV Paint

A UV paint was prepared in the same manner as in Preparation Example 1, except that 26 wt % of urethane acrylate-based oligomer was used, and the copolymer represented by Chemical Formula 1 was not used in Preparation Example 1.

### Example 1: Preparation of Nail Art Sticker

A polyethylene terephthalate film having a thickness of 100 μm was laminated and adhered to the upper surface of a 40 μm-thick base layer formed of elastic polyurethane. The UV paint prepared in Preparation Example 1 was coated on the lower surface of the base layer to form a first design layer and cured with UV. A mirror layer was deposited on the upper surface of the first design layer.

A high transparent & clear pressure sensitive adhesive (HTC PSA) was applied to the upper surface of the mirror layer at a thickness of 50 μm to form a pressure sensitive adhesive sheet, and a release liner film was attached to the upper surface of the transparent pressure sensitive adhesive at a thickness of 50 μm.

The polyethylene terephthalate film was removed from the base layer, and the UV paint prepared in Preparation Example 1 was coated on the polyethylene terephthalate film-removal surface, and cured with UV to form a second design layer.

### Comparative Example 1: Preparation of Nail Art Sticker

A nail art sticker was prepared in the same manner as in Example 1, except that a UV paint prepared in Preparation Example 2 was used instead of the UV paint prepared in Preparation Example 1 used in Example 1.

### Test Example 1: Durability Test

The durability was evaluated using the nail art stickers prepared in Example 1 and Comparative Example 1.

The evaluation for the nail art stickers was conducted by selecting a total of 10 subjects. Specifically, in 5 persons, the nail art sticker prepared in Example 1 was attached to the middle finger and the nail art sticker prepared in Comparative Example 1 was attached to the index finger. In other 5 persons, the nail art sticker prepared in Example 1 was attached to the index finger and the nail art sticker prepared in Comparative Example 1 was attached to the middle finger.

The subjects lived in real life after attaching the nail art stickers for one month, and then the durability was evaluated by checking whether chipping occurred in the second design layer of the nail art stickers attached.

The durability evaluation results were confirmed as shown in Table 1 below.

TABLE 1

| | Number of chipping |
|---|---|
| Nail art sticker | occurrence of total 10 |
| Example 1 | 0 |
| Comparative Example 1 | 3 |

As can be seen in Table 1, the nail art sticker of Example 1 of the present disclosure did not cause any chipping in the second design layer even after being used for one month. On the other hand, the occurrence of chipping was confirmed in three of the nail art stickers of Comparative Example 1.

As described above, in the detailed description of the present disclosure, the preferred embodiments of the present disclosure have been described, but the best embodiment of the present disclosure is illustratively described and the present disclosure is not limited thereto. Further, it will be apparent to all those skilled in the art that various modifications and imitations can be made without departing from the scope of the technical spirit of the present disclosure.

Therefore, the scope of the present disclosure is not limited to the above-described embodiments, but may be implemented in various forms of embodiments within the scope of the appended claims. In addition, without departing from the gist of the present disclosure claimed in the appended claims, it is considered that various modifications made by those skilled in the art cover the appended claims of the present disclosure.

What is claimed is:

1. A manufacturing method for a nail art sticker comprising:
a base step of laminating and adhering a polyethylene terephthalate film to an upper surface of a base layer formed of elastic polyurethane;
a first design layer forming step of forming a first design layer by coating a UV paint on a lower surface of the base layer;
a printing step of depositing a mirror layer or a thin metal layer on an upper surface of the first design layer;
a pressure sensitive adhesive sheet forming step of coating a transparent pressure sensitive adhesive on an upper surface of the mirror layer or the thin metal layer and attaching a release liner film onto an upper surface of the transparent pressure sensitive adhesive; and
a second design layer forming step of forming a second design layer by removing the polyethylene terephthalate film from the base layer and coating the UV paint on the polyethylene terephthalate film removal surface,
wherein the UV paint includes 12 to 24 wt % of urethane acrylate-based oligomer, 5 to 10 wt % of 2-propenoic acid, 2.5 to 5 wt % of 1,6-hexanediol diacrylate, 5 to 10 wt % of exo-1,7,7-trimethylbicyclo[2.2.1]heptyl acrylate, 0.5 to 3 wt % of phenylbis(2,4,6-trimethylbenzoyl)phosphine oxide, 0.5 to 3 wt % of α-hydroxy ketone, 3 to 10 wt % of a copolymer represented by the following Chemical Formula 1, and 40 to 60 wt % of a solvent: 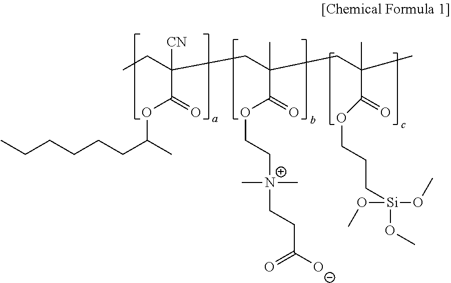
wherein, a, b, and c are mole fractions, and
wherein a is 0.3 to 0.7, b is 0.1 to 0.3, c is 0.2 to 0.4, and a+b+c is 1.

2. The manufacturing method for the nail art sticker of claim 1, wherein in the base step, the thickness of the base layer is formed at a thickness of 25 μm to 75 μm.

3. The manufacturing method for the nail art sticker of claim 1, wherein in the base step, the thickness of the polyethylene terephthalate film is formed at a thickness of 75 μm to 150 μm.

4. The manufacturing method for the nail art sticker of claim 1, wherein the first design layer forming step comprises:
a paint disposing step of disposing a UV paint on one side of a mold;
a pressing step of seating a lower surface of the base layer onto the mold and then inserting the mold into a roller;
a UV forming step of coating and attaching the UV paint on the lower surface of the base layer by pressing the roller and forming various patterns on the UV paint to form the first design layer; and
a curing step of curing a corresponding resin layer by irradiating UV toward the first design layer.

5. The manufacturing method for the nail art sticker of claim 1, wherein the second design layer forming step comprises:
a paint disposing step of disposing a UV paint on one side of a mold;
a pressing step of seating the polyethylene terephthalate film removal surface of the base layer onto the mold and then inserting the mold into a roller;
a UV forming step of coating and attaching the UV paint on the polyethylene terephthalate film removal surface of the base layer by pressing the roller and forming various patterns on the UV paint to form the first design layer; and
a curing step of curing a corresponding resin layer by irradiating UV toward the second design layer.

6. The manufacturing method for the nail art sticker of claim 1, wherein in the printing step, a reflective surface is formed on the upper surface of the first design layer so that the design layer exhibits luminance.

7. The manufacturing method for the nail art sticker of claim 1, wherein in the pressure sensitive adhesive forming step, the thickness of the transparent pressure sensitive adhesive is formed at a thickness of 25 μm to 125 μm.
